(19) United States
(12) Patent Application Publication
(10) Pub. No.: US 2021/0337376 A1
(43) Pub. Date: Oct. 28, 2021

(54) METHOD FOR AUTOMATICALLY UPGRADING FIRMWARE OVER THE AIR AND WIRELESS NODE

(71) Applicant: REALTEK SEMICONDUCTOR CORP., Hsinchu (TW)

(72) Inventors: Bin Shao, Hsinchu (TW); Yang Huang, Hsinchu (TW); Shi-Meng Zou, Hsinchu (TW); Qi Liu, Hsinchu (TW)

(73) Assignee: REALTEK SEMICONDUCTOR CORP., Hsinchu (TW)

(21) Appl. No.: 16/943,367

(22) Filed: Jul. 30, 2020

(30) Foreign Application Priority Data
Apr. 27, 2020 (CN) 202010344507.4

(51) Int. Cl. H04W 8/24; H04W 4/06; H04W 8/00; H04W 76/14; H04W 76/30

(52) U.S. Cl. CPC H04W 8/24; H04W 4/06; H04W 84/20; H04W 76/14; H04W 76/30; H04W 8/005

(57) ABSTRACT

A method for automatically upgrading firmware over the air and a wireless node are provided. The method is applied to a wireless local area network including a plurality of wireless nodes. The method includes: broadcasting, by the wireless node, firmware information, and maintaining a connectable state; scanning, by each of the wireless nodes, other wireless nodes, where when the wireless node scans another wireless node with an old version of firmware information, the scanning wireless node serves as a master wireless node, and the another scanned wireless node serves as a slave wireless node; connecting, by the master wireless node, to the slave wireless node, and sending an upgrade instruction to the slave wireless node; performing, by the slave wireless node, a firmware upgrade according to the upgrade instruction to update to a new version of firmware; and disconnecting the master wireless node from the slave wireless node.

### CROSS-REFERENCE TO RELATED APPLICATION

This non-provisional application claims priority under 35 U.S.C. § 119(a) to Patent Application No. 202010344507.4 filed in China, P.R.C. on Apr. 27, 2020, the entire contents of which are hereby incorporated by reference.

### BACKGROUND

### Technical Field

The present invention relates to a firmware update technology, and in particular, to a method for automatically upgrading firmware over the air and a master wireless node and a slave wireless node.

### Related Art

In a wireless network, such as a Bluetooth local area network, a function of an over-the-air upgrade of a wireless node is very important. In the method of over-the-air upgrade, an existing problem of the wireless node may be repaired, and the wireless node may be upgraded to add a new function.

In an existing over-the-air upgrade technology, a technician usually manually operates a specific management device to upgrade each wireless node in sequence. However, with the development of the Internet of Things, there are increasing types and numbers of wireless nodes used in wireless networks. Manually upgrading a device of each wireless node one by one is not only slow, but also easily causes an error due to a careless mistake of a man-made operation.

### SUMMARY

In view of this, a method for automatically upgrading firmware over the air applied to a wireless local area network is provided. The wireless local area network includes a plurality of wireless nodes. The method includes: broadcasting, by the wireless nodes, firmware information and maintaining a connectable state; scanning, by each of the wireless nodes, other wireless nodes, where when the wireless node scans another wireless node with an old version of the firmware information, the scanning wireless node serves as a master wireless node and the another wireless node serves as a slave wireless node; connecting, by the master wireless node, to the slave wireless node and sending an upgrade instruction to the slave wireless node; performing, by the slave wireless node, a firmware upgrade according to the upgrade instruction to update to a new version of firmware; and disconnecting the master wireless node from the slave wireless node.

According to some embodiments, the wireless local area network is a Bluetooth local area network.

According to some embodiments, the firmware information further includes a firmware version and at least one identification code.

According to some embodiments, the identification code further includes a company identification code and a product identification code.

According to some embodiments, the master wireless node continues to scan and search for the wireless nodes nearby.

According to some embodiments, the slave wireless node enables a new version of firmware; or the slave wireless node is to be restarted to implement the new version of firmware.

The present invention further provides a master wireless node applied to a Bluetooth local area network. The master wireless node includes a Bluetooth wireless module, a storage module, and a processor. The Bluetooth wireless module is configured to connect to the Bluetooth local area network. The storage module is configured to store a new version of firmware information. The processor is electrically connected to the Bluetooth wireless module and the storage module and is configured to: execute a scanning program to search for a slave wireless node with an old version of firmware information; connect to the slave wireless node in response to the slave wireless node; send an upgrade instruction to the slave wireless node to update an old version of firmware of the slave wireless node; and be disconnected from the slave wireless node.

The present invention further provides a slave wireless node applied to a Bluetooth local area network. The slave wireless node includes a Bluetooth wireless module, a storage module, and a processor. The Bluetooth wireless module is configured to connect to the Bluetooth local area network. The storage module is configured to store an old version of firmware information. The processor is electrically connected to the Bluetooth wireless module and the storage module. The processor broadcasts the old version of firmware information through the Bluetooth wireless module and maintains a connectable state. The processor is configured to: be connected to a master wireless node; receive an upgrade instruction from the master wireless node; update an old version of firmware in the processor to a new version of firmware in response to the upgrade instruction, and store a new version of firmware information corresponding to the new version of firmware in the storage module; and enable the new version of firmware.

Based on the foregoing, in order to overcome a shortcoming of the over-the-air upgrade method for the existing wireless local area network, the present invention provides a rapid and automatic over-the-air upgrade technology to rapidly and effectively upgrade firmware of all wireless nodes in the wireless local area network by utilizing a communication-type upgrade method of automatic mutual upgrade between wireless nodes, so that not only upgrade time may be effectively shortened, but also no error is easily caused in automatic upgrade. Therefore, all of the wireless nodes can have the latest version of firmware.

### BRIEF DESCRIPTION OF THE DRAWINGS

FIG. 1 is a schematic diagram of a wireless local area network according to an embodiment of the present invention.

FIG. 2 is a schematic diagram of a state of a wireless node according to an embodiment of the present invention.

FIG. 3 is a flowchart of a method for automatically upgrading firmware over the air according to an embodiment of the present invention.

FIG. 4 is a schematic circuit block diagram of a wireless node according to an embodiment of the present invention.

FIG. 5 is a working flowchart of a master wireless node according to an embodiment of the present invention.

FIG. 6 is a working flowchart of a slave wireless node according to an embodiment of the present invention.

FIG. 7 is a schematic diagram of a fission upgrade of a wireless local area network according to an embodiment of the present invention.

FIG. 8 is a schematic diagram of a linear upgrade of a wireless local area network according to an embodiment of the present invention.

FIG. 9 is a schematic diagram of a gradual upgrade of a wireless local area network according to another embodiment of the present invention.

### DETAILED DESCRIPTION

A method for automatically upgrading firmware over the air provided in the present invention is applied to a wireless local area network to upgrade firmware of a low version of a wireless node (a slave wireless node) by using a high version of a wireless node (a master wireless node). The firmware upgrade herein includes repairing or correcting an existing error or problem of a network node, adding additional hardware and software supports, and improving an original function or adding a new function to the original function to ensure that each wireless node has the latest version of firmware.

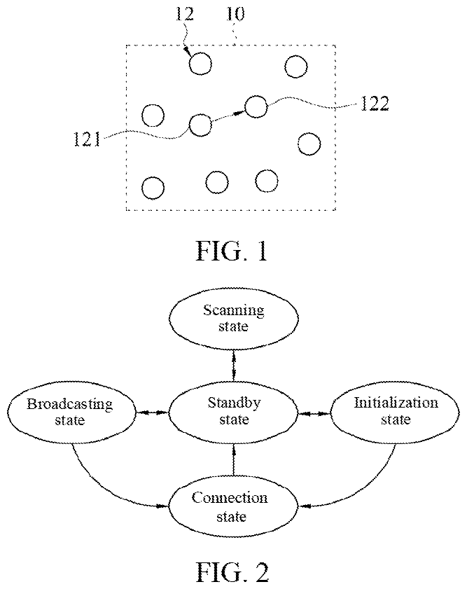

FIG. 1 is a schematic diagram of a wireless local area network according to an embodiment of the present invention. FIG. 2 is a schematic diagram of a state of a wireless node according to an embodiment of the present invention. Referring to both FIG. 1 and FIG. 2, a wireless local area network 10 includes a plurality of wireless nodes 12. In one embodiment, the wireless local area network 10 is a Bluetooth local area network. Each wireless node 12 may enter a broadcasting state, a scanning state, or an initialization state from a standby state. The wireless node 12 meeting the initialization state enters a connection state simultaneously with another wireless node 12 in the broadcasting state to perform a firmware update. In addition, the wireless node 12 may return to the standby state when the broadcasting state, the scanning state, the initialization state, or the connection state is completed. In an embodiment, the broadcasting state and the scanning state may be performed simultaneously or interactively. Each wireless node 12 may selectively serve as a master wireless node or a slave wireless node according to a new or old version of the firmware information of the wireless node. In other words, the wireless node 12 with a new version of firmware information serves as the master wireless node, and the wireless node 12 with the old version of the firmware information serves as the slave wireless node.

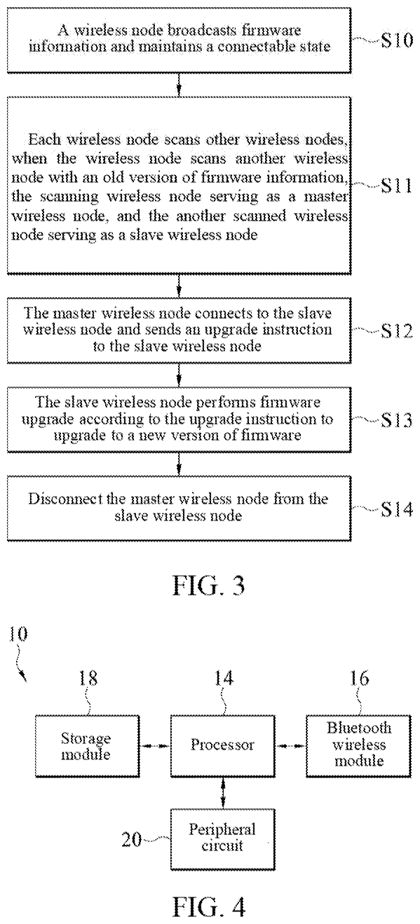

FIG. 3 is a flowchart of a method for automatically upgrading firmware over the air according to an embodiment of the present invention. Referring to FIG. 1 to FIG. 3, the method for automatically upgrading firmware over the air is applied to the wireless local area network 10. This method includes steps S10 to S14. First, as shown in step S10, the wireless node 12 broadcasts firmware information in a first predetermined period and maintains a connectable state. In this case, the wireless node 12 is in a broadcasting state. The connectable state includes a be-connected state and an upgradable state. As shown in step S11, each wireless node 12 scans other wireless nodes 12 in a second predetermined period. In this case, the wireless node 12 is in a scanning state. When one of the wireless nodes 12 scans another wireless node 12 with an old version of firmware information, the scanning wireless node 12 serves as a master wireless node 121, and the another scanned wireless node 12 serves as a slave wireless node 122. In an embodiment, the firmware information further includes a firmware version, a company identification code, and a product identification code. Therefore, when the wireless node 12 continuously scans other wireless nodes 12 nearby, the wireless node first filter out another wireless node 12 with the same company identification code and product identification code as those of the another wireless node, and then compares firmware versions of the wireless node and the another wireless node. If a grade of the firmware version of another wireless node 12 is higher than or equal to a grade of the wireless node, another wireless node 12 is ignored. If the firmware version of another wireless node 12 is lower than the grade of the wireless node, it means that another wireless node 12 with an old version of firmware information is found, and a next step is performed.

As shown in step S12, the master wireless node 121 actively connects to the slave wireless node 122. In this case, the master wireless node 121 enters a connection state from an initialization state, and the slave wireless node 122 enters the connection state from a broadcasting state. In addition, the master wireless node 121 sends an upgrade instruction to the slave wireless node 122. As shown in step S13, the slave wireless node 122 performs a firmware upgrade according to the upgrade instruction to update to the new version of firmware. In an embodiment, the slave wireless node 122 may further transmit a request signal to the master wireless node 121 after receiving the upgrade instruction, so that the master wireless node 121 correspondingly transmits upgrade information to the slave wireless node 122 according to the request signal. Therefore, the wireless node 122 may upgrade the original old version of firmware to the new version of firmware after receiving the upgrade information. Finally, as shown in step S14, after the upgrade is completed, the master wireless node 121 is disconnected from the slave wireless node 122.

In an embodiment, after the master wireless node 121 is disconnected from the slave wireless node 122, the master wireless node 121 continues to scan and search for other wireless nodes 12 nearby, and the slave wireless node 122 may directly enable the new version of firmware, or the slave wireless node 122 is to be restarted to execute a new version of firmware. In this case, the slave wireless node 122 also becomes a wireless node with a latest version of firmware information, and may continue to scan or update other wireless nodes 12.

In an embodiment, if a plurality of wireless nodes 12 are scanned within a predetermined time interval, an order in which updating and upgrading are performed is not limited, and a to-be-upgraded wireless node 12 may be randomly selected from the plurality of wireless nodes, or sorting may be performed according to signal strength, or an update is performed successively in a manner of sorting according to Bluetooth addresses.

FIG. 4 is a schematic circuit block diagram of a wireless node according to an embodiment of the present invention. Referring to FIG. 1 to FIG. 4, a wireless node 12 is applied to a Bluetooth local area network, and includes a processor 14, a Bluetooth wireless module 16, a storage module 18, and a peripheral circuit 20. The processor 14 is electrically connected to the Bluetooth wireless module 16, the storage module 18, and the peripheral circuit 20. The Bluetooth wireless module 16 is configured to connect to a Bluetooth local area network, and the storage module 18 is configured to store a new version of firmware information or an old version of firmware information. In an embodiment, the storage module 18 may be a random access memory (RAM) and a flash memory. Because the wireless node 12 may be selected as the master wireless node 121 or the slave wireless node 122 according to the version of the firmware information, the processor 14 performs different workflows according to different tasks. In an embodiment, the processor 14 may be, but not limited to, a central processing unit (CPU), a microprocessor, or other signal processors.

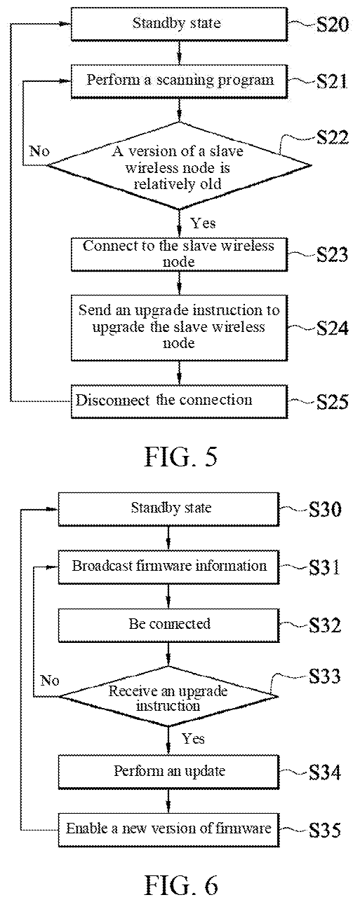

Referring to FIG. 1, FIG. 4, and FIG. 5, when the wireless node 12 has a new version of firmware information as a master wireless node 121, the processor 14 is configured to perform the following steps: performing step S21 from a standby state shown in step S20 to execute a scanning program to search for the slave wireless node 122 with an old version of firmware information. As shown in step S22, it is determined whether a version of the scanned slave wireless node 122 is relatively old, if not, returning to step S21 and continuing to scan other wireless nodes 12; and if the version of the scanned slave wireless node 122 is relatively old, as shown in step S23, the slave wireless node 122 is connected in response to the found slave wireless node. As shown in step S24, the processor 14 sends an upgrade instruction to the slave wireless node 122 to update the old version of firmware of the slave wireless node 122. Finally, as shown in step S25, the slave wireless node 122 is disconnected.

Referring to FIG. 1, FIG. 4, and FIG. 6, when the wireless node 12 has an old version of firmware information as a slave wireless node 122, the processor 14 is configured to perform the following steps: performing step S31 from a standby state shown in step S30 to broadcast an old version of firmware information through the Bluetooth wireless module 16 and maintain a connectable state. As shown in step S32, a master wireless node 121 is connected. As shown in step S33, it is determined whether an upgrade instruction is received from the master wireless node 121. If the upgrade instruction is not received, returning to step S31 to continue broadcasting firmware information. If the upgrade instruction is received, performing a next step S34. As shown in step S34, in response to the upgrade instruction, an update program is executed, the old version of firmware in the processor 14 is updated to a new version of firmware, and the new version of firmware information corresponding to the new version of firmware is stored in the storage module 18 to replace the old version of firmware information originally stored in the storage module 18. Finally, as shown in step S35, the new version of firmware is enabled. For the detailed update and enabling processes, reference may be made to the previous description, and details thereof are not described herein again.

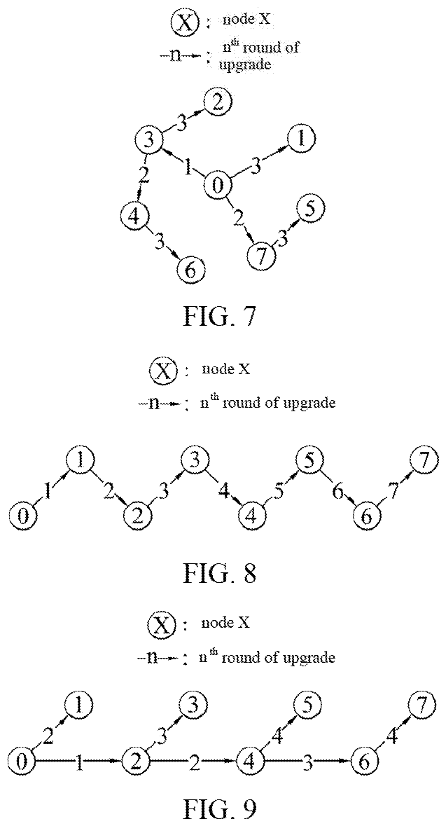

The present invention has different effects in different wireless local area network topologies. In an embodiment, during each round of upgrade, a wireless node with a high version of firmware information (a new version of firmware information) in the wireless local area network may find and upgrade a wireless node with a low version of firmware information (the old version of firmware information), the present invention may achieve highest time efficiency, that is, achieving a “fission” effect. In an embodiment, all wireless nodes are in relatively close positions, and any two wireless nodes may find and upgrade each other. Referring to FIG. 7, during a fission upgrade, a total of three rounds of upgrades are needed, and a number of wireless nodes with the high version of firmware information increases exponentially in a manner of 1, 2, 4, 8, . . . . In detail, in this wireless local area network, there are a total of 8 wireless nodes 0-7. A wireless node 0 is a wireless node with the high version of firmware information at the earliest. In a first round, the wireless node 0 upgrades a wireless node 3. In a second round, the wireless node 0 upgrades a wireless node 7, and the wireless node 3 upgrades a wireless node 4. In a third round, the wireless node 0 upgrades the wireless node 1, the wireless node 3 upgrades a wireless node 2, the wireless node 7 upgrades a wireless node 5, and the wireless node 4 upgrades a wireless node 6. Therefore, for a wireless local area network with N wireless nodes, traditional upgrade time complexity is O (N), while upgrade time complexity in the present invention is only O (log N). If a scale of the wireless local area network is relatively large, the network upgrade time is greatly shortened.

In an embodiment, during each round of upgrade, when only one wireless node with a high version of firmware information in the wireless local area network may find and upgrade a wireless node with a low version of firmware information, upgrade efficiency of the present invention is relatively low, that is achieving a “linear” effect. In an embodiment, all wireless nodes are lined up, and only adjacent wireless nodes may find and upgrade each other. Referring to FIG. 8, in the linear upgrade, a total of 7 rounds of upgrades are needed. A number of wireless nodes with a high version of firmware information increases linearly in a manner of 1, 2, 3, 4, 5, . . . . In detail, in this wireless local area network, there are a total of 8 wireless nodes 0-7. A wireless node 0 is a wireless node with the high version of firmware information at the earliest. In a first round, the wireless node 0 upgrades a wireless node 1. In a second round, the wireless node 1 upgrades a wireless node 2. In a third round, the wireless node 2 upgrades a wireless node 3. In a fourth round, the wireless node 3 upgrades a wireless node 4. In a fifth round, the wireless node 4 upgrades a wireless node 5. In a sixth round, the wireless node 5 upgrades a wireless node 6. In a seventh round, the wireless node 6 upgrades a wireless node 7. In this case, although efficiency of the present invention cannot be improved, manual operations which are troublesome and easily cause an error are avoided.

In an embodiment, all wireless nodes are lined up, and adjacent wireless nodes may find and upgrade each other. Referring to FIG. 9, in a gradual upgrade, a total of four rounds of upgrade are needed, and a number of wireless nodes with a high version of firmware information gradually increases in a manner of 1, 2, 4, 6, 8, . . . . In detail, in the wireless local area network, there are a total of 8 wireless nodes 0-7. A wireless node 0 is a wireless node with a high version of firmware information at the earliest. In a first round, the wireless node 0 upgrades a wireless node 2. In a second round, the wireless node 0 upgrades a wireless node 1, and the wireless node 2 upgrades a wireless node 4. In a third round, the wireless node 2 upgrades a wireless node 3, and the wireless node 4 upgrades a wireless node 6. In a fourth round, the wireless node 4 upgrades a wireless node 5, and the wireless node 6 upgrades a wireless node 7. Therefore, efficiency of the upgrade in the present invention is relatively improved. For a larger wireless local area network, time for the network upgrade is also relatively shortened.

Based on the foregoing, in order to overcome a shortcoming of the over-the-air upgrade method for the existing wireless local area network, the present invention provides a rapid and automatic over-the-air upgrade technology to rapidly and effectively upgrade firmware of all wireless nodes in the wireless local area network by utilizing a communication-type upgrade method of automatic mutual upgrade between wireless nodes, so that not only upgrade time may be effectively shortened, but also no error is easily caused in automatic upgrade. Therefore, all of the wireless nodes can have the latest version of firmware.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

1. A method for automatically upgrading firmware over the air, applied to a wireless local area network comprising a plurality of wireless nodes, the method comprising:
broadcasting, by the wireless nodes, firmware information, and maintaining a connectable state;
scanning, by each of the wireless nodes, other wireless nodes, wherein when the wireless node scans another wireless node with an old version of the firmware information, the scanning wireless node serves as a master wireless node, and the another scanned wireless node serves as a slave wireless node;
connecting, by the master wireless node, to the slave wireless node, and sending an upgrade instruction to the slave wireless node;
performing, by the slave wireless node, a firmware upgrade according to the upgrade instruction to update to a new version of firmware; and
disconnecting the master wireless node from the slave wireless node.

2. The method for automatically upgrading firmware over the air according to claim 1, wherein the wireless local area network is a Bluetooth local area network.

3. The method for automatically upgrading firmware over the air according to claim 1, wherein the firmware information further comprises a firmware version and at least one identification code.

4. The method for automatically upgrading firmware over the air according to claim 3, wherein the at least one identification code further comprises a company identification code and a product identification code.

5. The method for automatically upgrading firmware over the air according to claim 1, further comprising: continuing, by the master wireless node, to scan and search for the wireless nodes nearby.

6. The method for automatically upgrading firmware over the air according to claim 1, further comprising: enabling, by the slave wireless node, the new version of firmware.

7. The method for automatically upgrading firmware over the air according to claim 6, wherein the slave wireless node is to be restarted to execute the new version of firmware.

8-14. (canceled)
